(19) United States
(12) Patent Application Publication
(10) Pub. No.: US 2024/0257552 A1
(43) Pub. Date: Aug. 1, 2024

(54) NON-CONTACT THREE-DIMENSIONAL PALM VEIN MODELING METHOD AND APPARATUS, AND AUTHENTICATION METHOD

(71) Applicant: Qingdao O-Mec Biometrics Co., Ltd., Qingdao (CN)

(72) Inventors: Huabin Xu, Qingdao (CN); Zhengkang Sun, Qingdao (CN); Junqiang Zhang, Qingdao (CN); Dongdong Han, Qingdao (CN); Huamin Jin, Qingdao (CN); Jinwook Yi, Qingdao (CN); Yao Zheng, Qingdao (CN)

(21) Appl. No.: 18/601,719

(22) Filed: Mar. 11, 2024

Related U.S. Application Data
(63) Continuation of application No. PCT/CN2021/116230, filed on Sep. 2, 2021.

(51) Int. Cl. G06V 40/12; G06F 21/32; G06T 7/11; G06V 10/25; G06V 10/80; G06V 40/13; G06V 40/14

(52) U.S. Cl. CPC G06V 40/1347; G06F 21/32; G06T 7/11; G06V 10/25; G06V 10/806; G06V 40/1312; G06V 40/1365; G06V 40/14

(57) ABSTRACT

The present disclosure provides a non-contact three-dimensional palm vein modeling method, including: shooting palm images of M different positions, where a quantity of shot palm images of each different position is one or more, the different positions are positions of a palm relative to an image shooting apparatus; picking out a picked palm image satisfying a preset condition from the shot palm images, where a quantity of picked palm images of each position is one or more, and the quantity of picked palm images of each position is less than or equal to a quantity of shot palm images of the corresponding position; extracting palm vein feature data from the picked palm images; performing feature fusion on the palm vein feature data extracted from the picked palm images to form one first feature template; and forming a user feature template based on the one first feature template.

### CROSS-REFERENCE TO RELATED APPLICATION

This Application is a bypass continuation application of PCT/CN2021/116230. This application claims priorities from PCT Application No. PCT/CN2021/116230, filed Sep. 2, 2021, the content of which is incorporated herein in the entirety by reference.

### TECHNICAL FIELD

The present disclosure relates to a non-contact three-dimensional palm vein modeling method and apparatus, an authentication method, and an electronic device.

### BACKGROUND

Many apparatuses and methods are developed by using a recognition system for human biological characteristics such as a fingerprint, a face, an iris, and veins, and are widely used. Recently, with the spread of COVID-19 and the enhancement of personal hygiene, a contact biometric authentication method in which contact with a public device is needed and transmission through droplets (saliva) of others exists is gradually avoided. A representative contact authentication method uses a fingerprint and vein related device. In order to ensure authentication performance, a high-quality image needs to be shot at a specific distance, and thus a limitation exists.

The existing finger vein/palm vein recognition apparatus suggests performing contact guidance to obtain a correct image, and indicates this on a product. In addition, various guidance forms or placement manners are described as principal elements and protected by a patent.

In order to maximize recognition performance of biometric recognition, a high-quality equalization image is the most important element. International standards such as obtained image resolution (DPI) and FBI/GA related to image quality such as distortion and uniformity exist in fingerprint recognition as one of the oldest biometric recognition methods. In terms of face recognition, a scheme for obtaining a standardized image based on the ISO/IEC 19794-5 Amendment 1 (Face Image Data on Conditions for Taking Pictures) exists.

Reasons for the standardization of image acquisition for the biometric recognition include a compatibility problem between devices and the like, but the biggest reason is recognition/authentication performance. Although a finger vein/palm vein device does not have an image standard for a fingerprint/face, every device manufacturer tries to obtain an image with resolution and illumination uniformity as high as possible according to a standard of the device manufacturer by placing a finger/palm at a specific distance from a fixed position. This is because an image processing/pattern recognition algorithm for feature point extraction and authentication is optimized for corresponding resolution, and the best performance is achieved only when the finger or palm is at a corresponding position.

Recently, the palm vein device has been developed as a non-contact type. However, the current non-contact method is not a newly developed technology for the non-contact type, but only a form in which an algorithm developed in the prior art is used and a guiding support is removed. Although this is a non-contact method, it means that correct recognition performance is shown only when a hand is close to the position of the guiding support, and in other cases, the performance deteriorates dramatically.

### SUMMARY

In order to solve at least one of the above technical problems, the present disclosure provides a non-contact three-dimensional palm vein modeling method and apparatus, an authentication method, an electronic device, and a readable storage medium.

According to an aspect of the present disclosure, a non-contact three-dimensional palm vein modeling method is provided, comprising: shooting palm images of M different positions, wherein a quantity of shot palm images of each different position is one or more, the different positions are different positions of a palm relative to an image shooting apparatus, and M is greater than 1; picking out a picked palm image satisfying a preset condition from the shot palm images, wherein a quantity of picked palm images of each position is one or more, and the quantity of picked palm images of each position is less than or equal to a quantity of shot palm images of the corresponding position; extracting palm vein feature data from the picked palm images; performing feature fusion on the palm vein feature data extracted from the picked palm images to form one first feature template; and forming a user feature template based on the one first feature template.

According to at least one embodiment of the present disclosure, the method further comprises: obtaining optimal vector data of the picked palm image of each position, that is, obtaining an optimal picked palm image from the picked palm image of each position, and obtaining the optimal vector data of each position based on the optimal picked palm image; or obtaining optimal palm vein feature data from the palm vein feature data of the picked palm image of each position, and obtaining the optimal vector data of each position based on the optimal palm vein feature data; and forming the user feature template based on the one first feature template, that is, fusing the one first feature template with the optimal vector data of each position to form the user feature template.

According to at least one embodiment of the present disclosure, picking out the picked palm image satisfying the preset condition comprises: extracting regions of interest of the shot palm images; obtaining image vector data of the regions of interest; and comparing the image vector data of the palm images, to pick out the picked palm image satisfying the preset condition.

According to at least one embodiment of the present disclosure, in a process of comparing the image vector data of the shot palm images, the palm images are compared pairwise to pick out palm images with a high similarity of the different positions, wherein if a comparison threshold of two palm images is greater than a preset threshold, a similarity of the two palm images is considered to be high.

According to at least one embodiment of the present disclosure, obtaining the image vector data of the regions of interest comprises: dividing an image of the regions of interest into m local regions, and calculating a gradient magnitude d and a gradient angle θ of gradient information of a pixel, to obtain the image vector data; a calculation formula of the gradient magnitude d and the gradient angle θ is:

$$dx = I ( x + 1 , y ) - I ( x - 1 , y )$$

$$dy = I ( x , y + 1 ) - I ( x , y - 1 )$$

$$d = \sqrt{{( dx )}^{2} + {( dy )}^{2}}$$

$$θ = arctan ( dy / dx )$$

I(x+1, y) and I(x−1, y) respectively represent gray-scale values of pixels at adjacent positions (x+1, y) and (x−1, y) in a horizontal direction, and I(x, y+1) and I(x, y−1) respectively represent gray-scale values of pixels at adjacent positions (x, y+1) and (x, y−1) in a vertical direction; an expression of an image vector is vector=[w₁, w₂, . . . , wₘ]; and a calculation formula of a feature vector w is

$${w}_{k} = {\sum }_{j = 1}^{n} φ ( {d}_{k , j} , {θ}_{k , j} ) = [ {w}_{k , 1} , {w}_{k , 2} , … , {w}_{k , m} ] ,$$

wherein d_{k,j} and θ_{x,j} are the gradient magnitude d and the gradient angle θ of a j^{th} pixel in a k^{th} region, φ is a gradient histogram statistical function, k is greater than or equal to 1 and less than or equal to m, and n is a quantity of pixels in the k^{th} region.

According to at least one embodiment of the present disclosure, extracting the palm vein feature data from the picked palm images comprises: obtaining a key feature point of the picked palm image, wherein the key feature point does not change with a palm size, rotation and deflection of the palm, and palm image brightness, that is, calculating and searching response maps of the picked palm image in different Gaussian scale spaces by using a designed fuzzy kernel function, performing subtraction to obtain a Gaussian difference image, and then positioning a stable extreme point in a position space and a scale space; and establishing a descriptor for the key feature point, wherein the key feature point is a stable feature point, and the descriptor is stable feature data, that is, in a Gaussian scale space in which a pole point is located, taking the extreme point as an origin, counting gradients and directions of pixels in an adjacent region by using a histogram, to form the descriptor.

According to at least one embodiment of the present disclosure, in a case that the first feature template is formed, the method comprises: performing three-dimensional matching on the stable feature point to obtain a successfully matched key point, wherein the three-dimensional matching comprises: matching the descriptor of the stable feature point of an image to be matched, performing perspective transformation on a successfully matched stable feature point to switch the successfully matched stable feature point to a same coordinate system, performing matching on the stable feature point in the coordinate system, and removing an unstable feature point while ensuring overall consistency of the matching; and fusing successfully matched key points to form an optimal fusion feature point, wherein the optimal fusion feature point forms the first feature template, and comparison performed by using the optimal fusion feature point is not influenced by a size, a position, an angle, an inclination, and a shape of the palm.

According to one aspect of the present disclosure, an authentication method using the user feature template established by any one of the methods, comprises: obtaining user image vector data and user palm vein feature data of a palm image of a user to be authenticated; comparing the user image vector data with data of user feature templates, to pick out a user feature template with a high similarity; and comparing the user palm vein feature data with the data of the picked user feature template with a high similarity, to determine the user to be authenticated.

According to one aspect of the present disclosure, a non-contact three-dimensional palm vein modeling apparatus, comprising: an image shooting apparatus, configured to shoot palm images of M different positions, wherein a quantity of shot palm images of each different position is one or more, the different positions are different positions of a palm relative to the image shooting apparatus, and M is greater than 1; a picking apparatus, configured to pick out a picked palm image satisfying a preset condition from the shot palm images, wherein a quantity of picked palm images of each position is one or more, and the quantity of picked palm images of each position is less than or equal to a quantity of shot palm images of the corresponding position; a feature extracting apparatus, configured to extract palm vein feature data from the picked palm images; a first feature template generating apparatus, configured to perform feature fusion on the palm vein feature data extracted from the picked palm images to form one first feature template; and a user feature template generating apparatus, configured to form a user feature template based on the one first feature template.

According to one aspect of the present disclosure, an electronic device, comprising: a memory, wherein the memory stores execution instructions; and a processor, wherein the processor executes the execution instructions stored by the memory, to enable the processor to perform any one of the methods.

### BRIEF DESCRIPTION OF THE DRAWINGS

The accompanying drawings show exemplary embodiments of the present disclosure and, together with the description, serve to explain the principles of the present disclosure. These accompanying drawings are included to provide a further understanding of the present disclosure and are incorporated in and constitute a part of this specification.

FIG. 1 is a schematic flowchart of a non-contact palm vein recognition method according to an embodiment of the present disclosure.

FIG. 2 is a schematic diagram of image shooting according to an embodiment of the present disclosure.

FIG. 3 is a schematic diagram of image shooting according to an embodiment of the present disclosure.

FIG. 4 is a schematic diagram of image shooting according to an embodiment of the present disclosure.

FIG. 5 is a flowchart of a non-contact three-dimensional palm vein modeling method according to an embodiment of the present disclosure.

FIG. 6 is a flowchart of an authentication method according to another embodiment of the present disclosure.

FIG. 7 is a schematic structural diagram of a non-contact three-dimensional palm vein modeling apparatus according to an embodiment of the present disclosure.

FIG. 8 is a schematic structural diagram of a non-contact palm vein authentication apparatus according to an embodiment of the present disclosure.

### DETAILED DESCRIPTION

The present disclosure is further described in detail below with reference to the accompanying drawings and embodiments. It can be understood that the specific embodiments described herein are only used to explain related content, but are not intended to limit the present disclosure. It should be further noted that, for ease of description, only a part related to the present disclosure is shown in the accompanying drawings.

According to an embodiment of the present disclosure, a non-contact three-dimensional palm vein modeling method is provided.

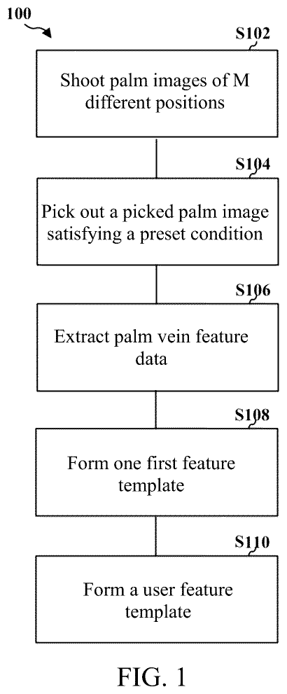

FIG. 1 shows a non-contact three-dimensional palm vein modeling method 100 according to an embodiment of the present disclosure.

In step S102, palm images of M different positions are shot. A quantity of shot palm images of each different position is one or more. The different positions are different positions of a palm relative to an image shooting apparatus. M is greater than 1.

In the step, images of a user's palm at two or more different positions are shot. A quantity of images shot for each position may be one or more. Preferably, two or more images are shot for each position. In the present disclosure, the palm images of at least two different positions need to be obtained.

In a process of shooting the palm image, the user may be guided to place the palm at an appropriate position. A guidance manner may be a vision guidance manner or a voice guidance manner.

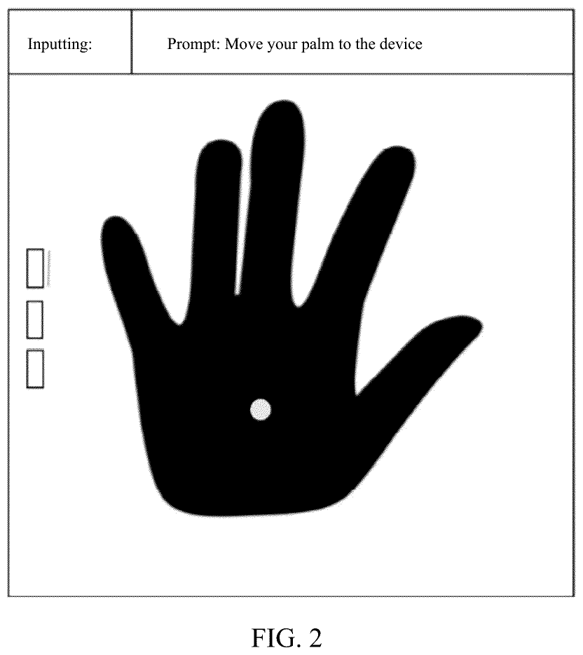

FIG. 2 shows that the user is guided by using a user interface (UI), to shoot a corresponding palm image. The user may move the palm, so that the palm is in a hand-shaped prompt region. As shown in FIG. 2, a dot may be used as a representative feature of the position of the palm. In addition, in the case that a shot image is recognized as not the palm image, the shot image may be not processed, and corresponding prompt information may be given.

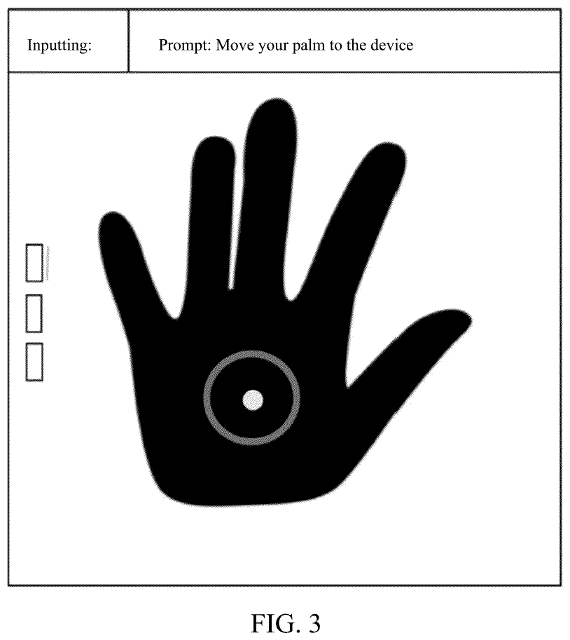

When the palm image is detected, related guidance information, for example, a circle as shown in FIG. 3, may appear in a palm display region. The palm may be moved in a plane direction (XY direction) of a display screen, so that a representative feature of the palm is in the circle or the palm image is in the hand-shaped prompt region, and the palm is guided to move in a Z direction (perpendicular to the XY direction) by using a prompt bar on a left side of FIG. 3, to position the palm in an appropriate input region.

A palm image of a correct position is shot, and position information and time information of the current palm image are recorded. The position information is preferably distance information (a distance between the palm and the image shooting apparatus), and may also be angular position information or the like.

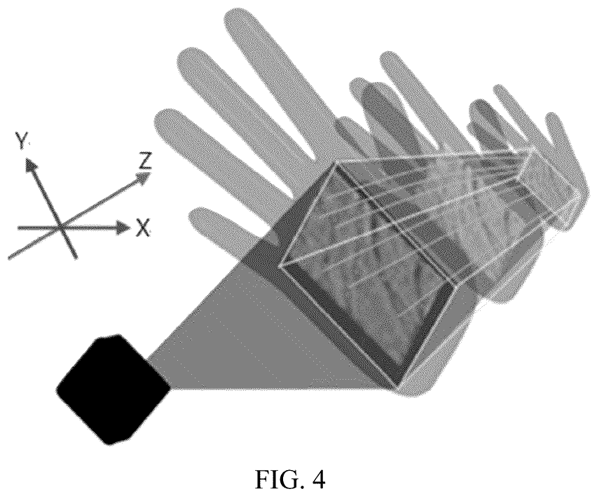

FIG. 4 is a schematic diagram of shooting palm images at three different positions.

In step S104, a picked palm image satisfying a preset condition is picked out from the shot palm images. A quantity of picked palm images of each position is one or more. The quantity of picked palm images of each position is less than or equal to a quantity of shot palm images of the corresponding position.

According to an embodiment of the present disclosure, in the case that the picked palm image satisfying the preset condition is picked out, a whole image of the palm image may be obtained, to pick out the picked palm image through a feature of the whole image. In a preferred embodiment of the present disclosure, a region of interest (ROI) of the shot palm image may be extracted, and the picked palm image may be picked out through a feature of the ROI.

The following is described in detail in a manner of the ROI. However, it should be noted that picking through a whole image or an image of another region of the palm image may also be performed in the corresponding manner, and thus the term “ROI image” mentioned below may be replaced with the term “palm image”.

The ROI is used as an example for description. In this manner, that the picked palm image satisfying the preset condition is picked out comprises: extracting the ROI of the shot palm image (the step may be omitted in the case that picking is performed through the palm image); obtaining image vector data of the regions of interest; and comparing the image vector data of the palm images, to pick out the picked palm image satisfying the preset condition.

In a process of comparing the image vector data of the shot palm images, the palm images are compared pairwise to pick out palm images with a high similarity of the different positions. If a comparison threshold of two palm images is greater than a preset threshold, a similarity of the two palm images is considered to be high.

After an ROI of a correct palm image is extracted, image vector data of the region of interest is obtained.

In a process of obtaining the image vector data, an ROI image is divided into m local regions, and a gradient magnitude d and a gradient angle θ of gradient information of a pixel are calculated, to obtain the image vector data.

A calculation formula of the gradient magnitude d and the gradient angle θ is as follows:

$$dx = I ( x + 1 , y ) - I ( x - 1 , y )$$

$$dy = I ( x , y + 1 ) - I ( x , y - 1 )$$

$$d = \sqrt{{( dx )}^{2} + {( dy )}^{2}}$$

$$θ = arctan ( dy / dx )$$

I(x+1, y) and I(x−1, y) respectively represent gray-scale values of pixels at adjacent positions (x+1, y) and (x−1, y) in a horizontal direction, and I(x, y+1) and I(x, y−1) respectively represent gray-scale values of pixels at adjacent positions (x, y+1) and (x, y−1) in a vertical direction; an expression of an image vector is vector=[w₁, w₂, . . . , wₘ]; and a calculation formula of a feature vector w is

$${w}_{k} = {\sum }_{j = 1}^{n} φ ( {d}_{k , j} , {θ}_{k , j} ) = [ {w}_{k , 1} , {w}_{k , 2} , … , {w}_{k , m} ] ,$$

wherein d_{k,j} and θ_{k,j} are the gradient magnitude d and the gradient angle θ of a j^{th} pixel in a k^{th} region, φ is a gradient histogram statistical function, k is greater than or equal to 1 and less than or equal to m, and n is a quantity of pixels in the k^{th} region.

In addition, it may be ensured, according to the position information of the obtained palm image, that the palm images of M different positions are obtained. It may be ensured, according to the time information of the obtained palm image, that a quantity of palm images obtained at each position is N, where N is greater than or equal to 1, and preferably two or more. In the case that a distance condition does not satisfy M and/or the quantity of palm image acquired at each position does not satisfy N, continuous acquisition or reacquisition is required.

The image vector data of the palm images is compared, to pick out the picked palm image satisfying the preset condition. Specifically, vectors of ROI images are compared pairwise to obtain ROI images with a high similarity. The ROI images with a high similarity mean that a calculated value of a vector similarity of the ROI images is greater than a threshold U1. Finally, one or more palm images with a high similarity are obtained. Preferably, a quantity of palm images with a high similarity is K, where K is greater than or equal to 1 and less than or equal to N.

One palm image of one position may be compared with each of palm images of the position, and a similarity value of the one palm image is obtained, and/or the one palm image is compared with the palm images of another position, and a similarity value of the one palm image is also obtained, and then the similarity values of the one palm image are added to obtain a total similarity value of the one palm image. The same processing is also performed on other palm images. Finally, the total similarity value of each palm image is obtained. The total similarity values of the palm images are compared, and the palm image whose total similarity value is maximum or greater than the threshold U1 at each distance is selected as the picked palm image at each distance.

As another example, a calculation method for the vector similarity comprises at least one of a norm L1, a norm L2, a Hamming distance, or a cosine distance. A calculation expression of the norm L2 is as follows:

$${L ( X , Y )}_{p} = {( {( {x}_{1} - {y}_{1} )}^{p} + {( {x}_{2} - {y}_{2} )}^{p} + … + {( {x}_{n} - {y}_{n} )}^{p} )}^{\frac{1}{p}} ,$$

and p∈[1,2], where X and Y respectively represent two vectors.

The method in the present disclosure may further include: ensuring that the palm images of M different positions are obtained, and the quantity of picked palm image of each position is K. If M is not satisfied and/or the quantity of picked palm image of each position does not satisfy K, reacquisition is required, and the above steps are repeated.

Through the process of picking out the picked palm images, the palm image with a high similarity may be retained, and the palm image with a low similarity may be removed. For each different position, a quantity of retained palm image with a high similarity may be greater than or equal to 1.

In step S106, palm vein feature data is extracted from the obtained picked palm images. That the palm vein feature data is extracted from the picked palm images comprises: obtaining a key feature point of the picked palm image, where the key feature point does not change with a palm size, rotation and deflection of the palm, and palm image brightness, that is, calculating and searching response maps of the picked palm image in different Gaussian scale spaces by using a designed fuzzy kernel function, performing subtraction to obtain a Gaussian difference image, and then positioning a stable extreme point in a position space and a scale space; and establishing a descriptor for the key feature point, where the key feature point is a stable feature point, and the descriptor is stable feature data, that is, in a Gaussian scale space in which a pole point is located, taking the extreme point as an origin, and counting gradients and directions of pixels in an adjacent region by using a histogram, to form the descriptor.

Obtaining a key feature point of the picked palm image comprises: calculating the response maps of the optimal image in different Gaussian scale spaces by using the designed fuzzy kernel function, performing subtraction to obtain the Gaussian difference image, and then positioning the stable extreme point in the position space and the scale space. A mathematical expression of the Gaussian difference image is:

$$DoG = \frac{1}{\sqrt{2 π}} ( \frac{1}{{σ}_{1}} {e}^{- ( {x}^{2} + {y}^{2} ) / 2 {σ}_{1}^{2}} - \frac{1}{{σ}_{2}} {e}^{- ( {x}^{2} + {y}^{2} ) / 2 {σ}_{2}^{2}} ) .$$

Establishing a descriptor for the key feature point comprises: taking the extreme point as an origin, and counting gradients and directions of pixels in an adjacent region by using a histogram, to form the descriptor.

In step S108, feature fusion is performed on the palm vein feature data extracted from the picked palm images to form one first feature template. The first feature template is a three-dimensional feature template obtained through features of different positions.

In the case that the first feature template is formed, three-dimensional matching is performed on the stable feature point, to obtain a successfully matched key point. The three-dimensional matching comprises: matching the descriptor of the stable feature point of an image to be matched, performing perspective transformation on a successfully matched stable feature point to switch the successfully matched stable feature point to a same coordinate system, performing matching on the stable feature point in the coordinate system, and removing an unstable feature point while ensuring overall consistency of the matching; and fusing successfully matched key points to form an optimal fusion feature point, where the optimal fusion feature point forms the first feature template, and comparison performed by using the optimal fusion feature point is not influenced by a size, a position, an angle, an inclination, and a shape of the palm. A stability expression of the stable feature point is:

$$f ( {p}_{k} ) = {\sum }_{i = 1}^{N} {γ}_{i} φ ( pos , w ) . If f ( {p}_{k} ) > T ,$$

the point pₖ is the stable feature point, where an image depth level is N, and γᵢ is a proportionality coefficient of images with different depths. Description of parameters: pos=[x,y], w=[w₁, . . . , wₙ], pₖ∈{p₁, . . . , pₘ}, T is 0.6, and a range of T is 0 to 1.

In step S110, a user feature template is formed based on the one first feature template. As an example, in step S110, the user feature template may be formed by fusing optimal vector data of optimal picked palm images at different distances based on the one first feature template.

The optimal picked palm image may be selected from the picked palm images. A specific selection manner may be the same as the above calculation manner of the similarity. Details are not described herein again. The picked palm image with the highest similarity of each position is obtained as the optimal picked palm image, and the vector data of the optimal picked palm image of each position is used as the optimal vector data of the position.

Optimal palm vein feature data may be obtained from the palm vein feature data of the picked palm image of each position, and the optimal vector data of each position is obtained based on the optimal palm vein feature data.

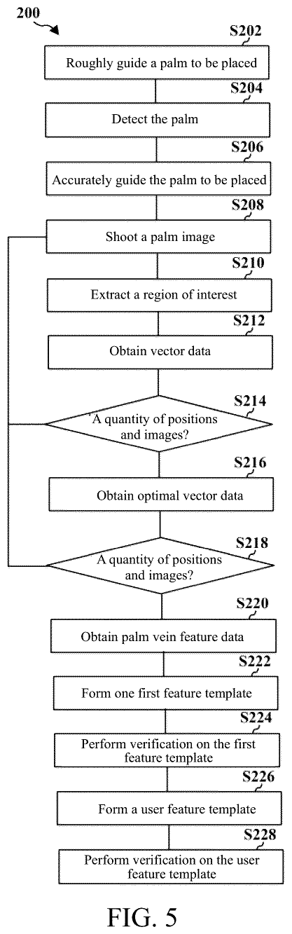

FIG. 5 shows a specific embodiment of a non-contact three-dimensional palm vein modeling method 200 according to an embodiment of the present disclosure. For details, refer to the above description. The three-dimensional modeling method 200 may include the following content.

In step S202, a user is roughly guided to place a palm at a corresponding position. After the palm is placed at the corresponding position, in step S204, the palm may be detected to determine whether it is a palm image, and if it is not a palm image, the user may be prompted. In step S206, the user may be accurately guided to place the palm. For example, refer to the related description in FIG. 2 and FIG. 3. In step S208, a palm image may be shot. In step S210, a region of interest in the shot palm image may be extracted (if an operation is not performed based on the region of interest, the step may be omitted).

In step S212, vector data of the image may be obtained from the region of interest. For a specific manner, refer to the above description. In step S214, it may be determined whether images of at least M different positions are acquired and a quantity of image of each position is greater than N. If so, the process turns to step S216; or else, the process returns to step S208.

In step S216, optimal vector data may be obtained. For a specific acquisition manner, refer to the above description. In step S218, it may be determined whether the images of at least M different positions are acquired and a quantity of picked palm image of each position is greater than K. If so, the process turns to step S220; or else, the process returns to step S208.

In step S220, palm vein feature data may be extracted from the picked palm image. In step S222, one first feature template may be formed. In step S224, verification is performed on the formed first feature template; and if the verification fails, reacquisition is performed. In step S226, a user feature template is formed based on the one first feature template. In step S228, verification is performed on the user feature template; if the verification succeeds, the modeling is successful; and if the verification fails, remodeling is performed.

The present disclosure further provides an authentication method using the user feature template established by the three-dimensional modeling method. The method may include: obtaining user image vector data and user palm vein feature data of a palm image of a user to be authenticated; comparing the user image vector data with data of user feature templates, to pick out a user feature template with a high similarity; and comparing the user palm vein feature data with the data of the picked user feature template with a high similarity, to determine the user to be authenticated.

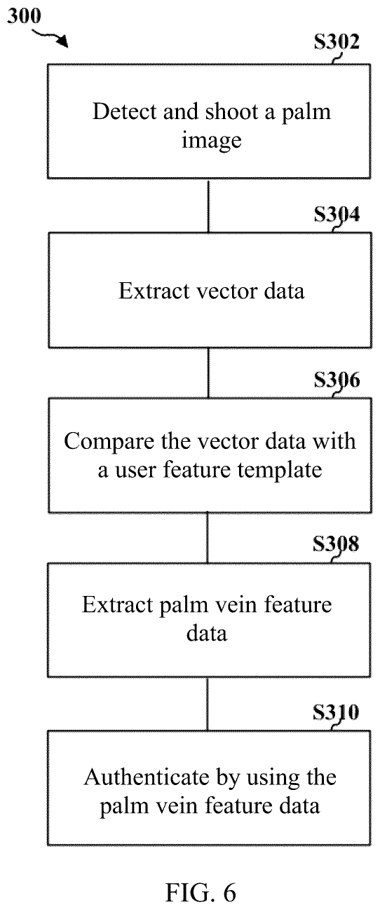

FIG. 6 shows an authentication method 300 according to an embodiment of the present disclosure. In the authentication method 300, in step S302, a palm image may be first detected and shot. In a detection process, whether it is a palm image may be determined. In a guidance process, a user may be guided to place a palm at an appropriate position. A guidance manner may be a vision guidance manner or a voice guidance manner. For example, FIG. 2 shows that the user is guided by using a user interface (UI), to shoot a corresponding palm image. The user may move the palm, so that the palm is in a hand-shaped prompt region. As shown in FIG. 2, a dot may be used as a representative feature of the position of the palm. In the case that a shot image is recognized as not the palm image, the shot image may be not processed, and corresponding prompt information may be given. When the palm image is detected, related guidance information, for example, a circle as shown in FIG. 3, may appear in a palm display region. The palm may be moved in a plane direction (XY direction) of a display screen, so that a representative feature of the palm is in the circle or the palm image is in the hand-shaped prompt region, and the palm is guided to move in a Z direction (perpendicular to the XY direction) by using a prompt bar on a left side of FIG. 3, to position the palm in an appropriate input region.

In embodiments of the present disclosure, a region of interest (ROI) of the shot palm image may be extracted, and the picked palm image may be picked out through a feature of the ROI. The following is described in detail in a manner of the ROI. However, it should be noted that picking through a whole image or an image of another region of the palm image may also be performed in the corresponding manner, and thus the term “ROI image” mentioned below may be replaced with the term “palm image”.

The ROI is used as an example for description. In this manner, picking out a picked palm image satisfying a preset condition comprises: extracting the ROI of the shot palm image (the step may be omitted in the case that picking is performed through the palm image).

In step S304, image vector data of the ROI is obtained. In step S306, the image vector data of the ROI is compared with a user feature template, and user data with a high similarity may be selected from the user feature template through comparison. For a specific obtaining manner and a comparison and calculation manner of the image vector data, refer to the above description.

For example, the image vector data obtained in step S304 may be compared with vector data of the user feature template, and in the case that a comparison result is greater than a threshold U2, a similarity is considered to be high. In this way, one or more user feature templates may be selected through comparison.

Because a comparison speed of the image vector data is extremely high, the user data with a high similarity may be quickly picked out from the user feature template through vector comparison.

In step S306, palm vein feature data of the shot palm image may be extracted. For an extraction method, refer to the related description of a creation method. In step S310, the user may be authenticated by comparing the palm vein feature data with the selected one or more user feature templates. If the comparison result is greater than a threshold U3, comparison is considered to be successful.

Therefore, according to the authentication method in the present disclosure, a corresponding user feature template may be first picked out through vector data comparison, and then user authentication is performed through the palm vein feature data. In this way, an authentication speed may be greatly increased.

In the authentication method, a manner of shooting and guiding the palm is the same as a modeling method, a manner of extracting the vector data is the same as the modeling method, and a manner of extracting the palm vein feature data is the same as the modeling method, and so forth. Details are not described herein again.

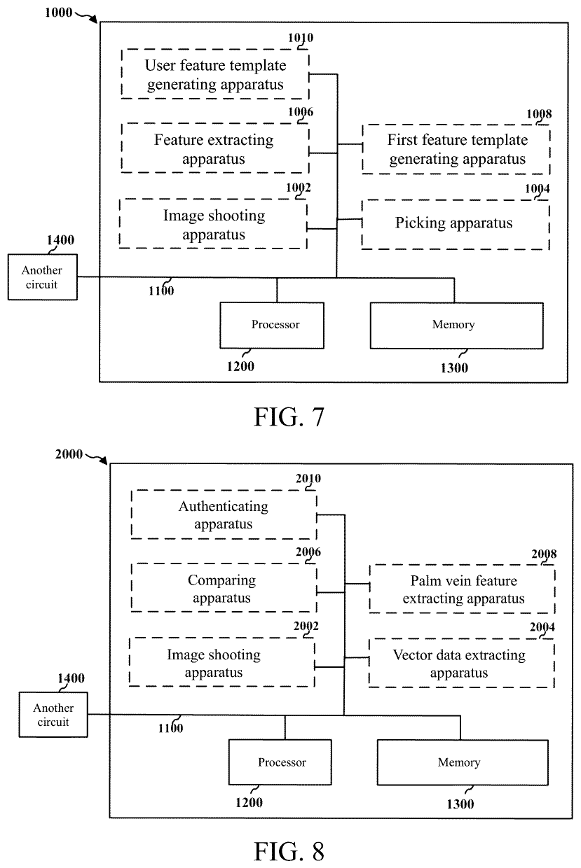

FIG. 7 and FIG. 8 show exemplary diagrams of an apparatus adopting a hardware implementation of a processing system. The apparatus may include corresponding modules for performing each step or several steps in the above flowcharts. Therefore, each step or several steps in the above flowcharts may be performed by the corresponding modules, and the apparatus may include one or more of these modules. The modules may be one or more hardware modules specifically configured to perform a corresponding step, or may be implemented by a processor configured to perform a corresponding step, or may be stored in a computer-readable medium to be implemented by a processor, or may be implemented by a specific combination.

The hardware structure may be implemented by using a bus architecture. The bus architecture may include any quantity of interconnected buses and bridges. This depends on specific application of hardware and overall design constraints. A bus 1100 connects various circuits comprising one or more processors 1200, memories 1300, and/or hardware modules together. The bus 1100 may further connect various other circuits 1400 such as a peripheral device, a voltage regulator, a power management circuit, and an external antenna.

The bus 1100 may be an Industry Standard Architecture (ISA) bus, a Peripheral Component Interconnect (PCI) bus, an Extended Industry Standard Architecture (EISA) bus, or the like. Buses may be classified into an address bus, a data bus, a control bus, and the like. For ease of representation, only one connecting line is used to represent the bus in the figure, but this does not mean that only one bus or only one type of bus exists.

Any process or method described in the flowcharts or otherwise described herein may be understood as representing a module, a segment, or a portion that comprises code of one or more executable instructions for implementing a specific logical function or a step in the process, and other implementation is included within the scope of the preferred embodiments of the present disclosure. Instead of in a shown or discussed order, involved functions may be performed substantially simultaneously or in an opposite order. This should be understood by those skilled in the art to which embodiments of the present disclosure pertain. The processor performs the above methods and processing. For example, method embodiments in the present disclosure may be implemented as a software program that is physically included in a machine-readable medium like a memory. In some embodiments, some or all of the software programs may be loaded and/or installed through the memory and/or a communication interface. When the software program is loaded into the memory and executed by the processor, one or more steps in the above methods may be performed. Alternatively, in another embodiment, the processor may be configured to perform one of the above methods in any other appropriate manner (for example, by means of firmware).

Logic and/or steps represented in the flowcharts or otherwise described herein may be specifically implemented in any readable storage medium for use by or in conjunction with an instruction execution system, apparatus, or device (for example, a system based on a computer, a system comprising a processor, or another system that can read instructions from the instruction execution system, apparatus, or device and execute the instructions).

In terms of the specification, the “readable storage medium” may be any apparatus that may include, store, communicate, transmit, or transfer a program for use by or in conjunction with an instruction execution system, apparatus, or device. More specific examples (a non-exhaustive list) of the readable storage medium include: an electrical connection part (electronic device) having one or more wires, a portable computer disk (magnetic device), a Random Access Memory (RAM), a Read-Only Memory (ROM), an Erasable Programmable Read-Only Memory (EPROM or a flash memory), an optical fiber device, and a Compact Disc Read-Only Memory (CDROM). In addition, the readable storage medium may even be paper on which a program is printed or another appropriate medium. This is because the program can be electronically obtained by, for example, performing optical scanning on paper or another medium, and then performing editing and interpretation, or processing in another appropriate manner if necessary, and then the program is stored in the memory.

It should be understood that portions of the present disclosure may be implemented in hardware, software, or a combination thereof. In the above embodiments, a plurality of steps or methods may be implemented by using software stored in the memory and executed by an appropriate instruction execution system. For example, if the plurality of steps or methods are implemented by hardware, as in another implementation, any one or combination of the following technologies that are well known in the art may be used: a discrete logic circuit having a logic gate circuit for implementing a logic function on a data signal, an application-specific integrated circuit having an appropriate combinational logic gate circuit, a Programmable Gate Array (PGA), a Field Programmable Gate Array (FPGA), and the like.

Those of ordinary skill in the art may understand that all or some of the steps of the above method embodiments may be implemented by a program instructing related hardware. The program may be stored in a readable storage medium. When executed, the program comprises one or a combination of the steps of the method embodiments.

In addition, each functional unit in each embodiment of the present disclosure may be integrated in one processing module, or each unit may physically exist alone, or two or more than two units may be integrated in one module. The integrated module may be implemented in a form of hardware, or may be implemented in a form of software functional module. When the integrated module is implemented in the form of software functional module and sold or used as an independent product, the integrated module may be stored in a readable storage medium. The storage medium may be a read-only memory, a magnetic disk, a compact disc, or the like.

FIG. 7 shows a non-contact three-dimensional palm vein modeling apparatus 1000. The three-dimensional modeling apparatus 1000 may include an image shooting apparatus 1002, a picking apparatus 1004, a feature extracting apparatus 1006, a first feature template generating apparatus 1008, and a user feature template generating apparatus 1010.

The image shooting apparatus 1002 shots palm images of M different positions. A quantity of shot palm images of each different position is one or more. The different positions are different positions of a palm relative to the image shooting apparatus. M is greater than 1.

The picking apparatus 1004 picks out a picked palm image satisfying a preset condition from the shot palm images. A quantity of picked palm images of each position is one or more, and the quantity of picked palm images of each position is less than or equal to a quantity of shot palm images of the corresponding position.

The feature extracting apparatus 1006 extracts palm vein feature data from the picked palm images.

The first feature template generating apparatus 1008 performs feature fusion on the palm vein feature data extracted from the picked palm images to form one first feature template.

The user feature template generating apparatus 1010 forms a user feature template based on the one first feature template.

For a specific implementation of each apparatus, refer to the related description in the above three-dimensional modeling method.

FIG. 8 shows an authentication apparatus 2000 according to an embodiment of the present disclosure. The authentication apparatus 2000 may include an image shooting apparatus 2002, a vector data extracting apparatus 2004, a comparing apparatus 2006, a palm vein feature extracting apparatus 2008, and an authenticating apparatus 2010. The same apparatuses in the authentication apparatus 2000 and the three-dimensional modeling apparatus 1000 may use a same module.

The image shooting apparatus 2002 may detect and shoot a palm image. The vector data extracting apparatus 2004 obtains image vector data of a region of interest. The comparing apparatus 2006 compares the image vector data of the region of interest with a user feature template. User data with a high similarity may be selected from the user feature template through comparison. The palm vein feature extracting apparatus 2008 may extract palm vein feature data of the shot palm image. The authenticating apparatus 2010 may authenticate a user by comparing the palm vein feature data with the user feature template. In addition, for specific content of the authentication apparatus 2000, refer to specific content of the above authentication method.

The present disclosure further provides an electronic device, comprising: a memory that stores execution instructions; and a processor or another hardware module. The processor or the another hardware module executes the execution instructions stored in the memory and performs the above methods.

The present disclosure further provides a readable storage medium that stores execution instructions. When executed by a processor, the execution instructions are used for implementing the above methods.

Those skilled in the art should understand that the foregoing embodiments are only for clearly describing the present disclosure and not intended to limit the scope of the present disclosure. For those skilled in the art, other changes or variations may further be made based on the foregoing disclosure, and these changes or variations also fall within the scope of the present disclosure.

1. A non-contact three-dimensional palm vein modeling method, comprising:
shooting palm images of M different positions, wherein a quantity of shot palm images of each different position is one or more, the different positions are different positions of a palm relative to an image shooting apparatus, and M is greater than 1;
picking out a picked palm image satisfying a preset condition from the shot palm images, wherein a quantity of picked palm images of each position is one or more, and the quantity of picked palm images of each position is less than or equal to a quantity of shot palm images of the corresponding position;
extracting palm vein feature data from the picked palm images;
performing feature fusion on the palm vein feature data extracted from the picked palm images to form one first feature template; and
forming a user feature template based on the one first feature template.

2. The method according to claim 1, further comprising: obtaining optimal vector data of the picked palm image of each position, that is, obtaining an optimal picked palm image from the picked palm image of each position, and obtaining the optimal vector data of each position based on the optimal picked palm image; or obtaining optimal palm vein feature data from the palm vein feature data of the picked palm image of each position, and obtaining the optimal vector data of each position based on the optimal palm vein feature data; and
forming the user feature template based on the one first feature template, that is, fusing the one first feature template with the optimal vector data of each position to form the user feature template.

3. The method according to claim 1, wherein picking out the picked palm image satisfying the preset condition comprises:
extracting regions of interest of the shot palm images;
obtaining image vector data of the regions of interest; and
comparing the image vector data of the palm images, to pick out the picked palm image satisfying the preset condition.

4. The method according to claim 3, wherein in a process of comparing the image vector data of the shot palm images, the palm images are compared pairwise to pick out palm images with a high similarity of the different positions, wherein if a comparison threshold of two palm images is greater than a preset threshold, a similarity of the two palm images is considered to be high.

5. The method according to claim 3, wherein obtaining the image vector data of the regions of interest comprises: dividing an image of the regions of interest into m local regions, and calculating a gradient magnitude d and a gradient angle θ of gradient information of a pixel, to obtain the image vector data;
a calculation formula of the gradient magnitude d and the gradient angle θ is:
$$dx = I ( x + 1 , y ) - I ( x - 1 , y )$$
$$dy = I ( x , y + 1 ) - I ( x , y - 1 )$$
$$d = \sqrt{{( dx )}^{2} + {( dy )}^{2}}$$
$$θ = arctan ( dy / dx )$$
I(x+1, y) and I(x−1, y) respectively represent gray-scale values of pixels at adjacent positions (x+1, y) and (x−1, y) in a horizontal direction, and I(x, y+1) and I(x, y−1) respectively represent gray-scale values of pixels at adjacent positions (x, y+1) and (x, y−1) in a vertical direction; an expression of an image vector is vector=[w₁, w₂, . . . , wₘ]; and a calculation formula of a feature vector w is
$${w}_{k} = {\sum }_{j = 1}^{n} φ ( {d}_{k , j} , {θ}_{k , j} ) = [ {w}_{k , 1} , {w}_{k , 2} , … , {w}_{k , m} ] ,$$
wherein d_{k,j} and θ_{k,j} are the gradient magnitude d and the gradient angle θ of a j^{th} pixel in a k^{th} region, φ is a gradient histogram statistical function, k is greater than or equal to 1 and less than or equal to m, and n is a quantity of pixels in the k^{th} region.

6. The method according to claim 1, wherein extracting the palm vein feature data from the picked palm images comprises:
obtaining a key feature point of the picked palm image, wherein the key feature point does not change with a palm size, rotation and deflection of the palm, and palm image brightness, that is, calculating and searching response maps of the picked palm image in different Gaussian scale spaces by using a designed fuzzy kernel function, performing subtraction to obtain a Gaussian difference image, and then positioning a stable extreme point in a position space and a scale space; and
establishing a descriptor for the key feature point, wherein the key feature point is a stable feature point, and the descriptor is stable feature data, that is, in a Gaussian scale space in which a pole point is located, taking the extreme point as an origin, counting gradients and directions of pixels in an adjacent region by using a histogram, to form the descriptor.

7. The method according to claim 6, wherein in a case that the first feature template is formed, the method comprises: performing three-dimensional matching on the stable feature point to obtain a successfully matched key point, wherein the three-dimensional matching comprises: matching the descriptor of the stable feature point of an image to be matched, performing perspective transformation on a successfully matched stable feature point to switch the successfully matched stable feature point to a same coordinate system, performing matching on the stable feature point in the coordinate system, and removing an unstable feature point while ensuring overall consistency of the matching; and fusing successfully matched key points to form an optimal fusion feature point, wherein the optimal fusion feature point forms the first feature template, and comparison performed by using the optimal fusion feature point is not influenced by a size, a position, an angle, an inclination, and a shape of the palm.

8. An authentication method using the user feature template established by the method according to claim 1, comprising:
obtaining user image vector data and user palm vein feature data of a palm image of a user to be authenticated;
comparing the user image vector data with data of user feature templates, to pick out a user feature template with a high similarity; and
comparing the user palm vein feature data with the data of the picked user feature template with a high similarity, to determine the user to be authenticated.

9. A non-contact three-dimensional palm vein modeling apparatus, comprising:
an image shooting apparatus, configured to shoot palm images of M different positions, wherein a quantity of shot palm images of each different position is one or more, the different positions are different positions of a palm relative to the image shooting apparatus, and M is greater than 1;
a picking apparatus, configured to pick out a picked palm image satisfying a preset condition from the shot palm images, wherein a quantity of picked palm images of each position is one or more, and the quantity of picked palm images of each position is less than or equal to a quantity of shot palm images of the corresponding position;
a feature extracting apparatus, configured to extract palm vein feature data from the picked palm images; a first feature template generating apparatus, configured to perform feature fusion on the palm vein feature data extracted from the picked palm images to form one first feature template; and
a user feature template generating apparatus, configured to form a user feature template based on the one first feature template.

10. An electronic device, comprising:
a memory, wherein the memory stores execution instructions; and
a processor, wherein the processor executes the execution instructions stored by the memory, to enable the processor to perform the method according to claim 1.

11. The authentication method using the user feature template established by the method according to claim 8, further comprising: obtaining optimal vector data of the picked palm image of each position, that is, obtaining an optimal picked palm image from the picked palm image of each position, and obtaining the optimal vector data of each position based on the optimal picked palm image; or obtaining optimal palm vein feature data from the palm vein feature data of the picked palm image of each position, and obtaining the optimal vector data of each position based on the optimal palm vein feature data; and
forming the user feature template based on the one first feature template, that is, fusing the one first feature template with the optimal vector data of each position to form the user feature template.

12. The authentication method using the user feature template established by the method according to claim 8, wherein picking out the picked palm image satisfying the preset condition comprises:
extracting regions of interest of the shot palm images;
obtaining image vector data of the regions of interest; and
comparing the image vector data of the palm images, to pick out the picked palm image satisfying the preset condition.

13. The authentication method using the user feature template established by the method according to claim 8, wherein in a process of comparing the image vector data of the shot palm images, the palm images are compared pairwise to pick out palm images with a high similarity of the different positions, wherein if a comparison threshold of two palm images is greater than a preset threshold, a similarity of the two palm images is considered to be high.

14. The authentication method using the user feature template established by the method according to claim 8, wherein obtaining the image vector data of the regions of interest comprises: dividing an image of the regions of interest into m local regions, and calculating a gradient magnitude d and a gradient angle θ of gradient information of a pixel, to obtain the image vector data;
a calculation formula of the gradient magnitude d and the gradient angle θ is:
$$dx = I ( x + 1 , y ) - I ( x - 1 , y )$$
$$dy = I ( x , y + 1 ) - I ( x , y - 1 )$$
$$d = \sqrt{{( dx )}^{2} + {( dy )}^{2}}$$
$$θ = arctan ( dy / dx )$$
I(x+1, y) and I(x−1, y) respectively represent gray-scale values of pixels at adjacent positions (x+1, y) and (x−1, y) in a horizontal direction, and I(x, y+1) and I(x, y−1) respectively represent gray-scale values of pixels at adjacent positions (x, y+1) and (x, y−1) in a vertical direction; an expression of an image vector is vector=[w₁, w₂, . . . , wₘ]; and a calculation formula of a feature vector w is
$${w}_{k} = {\sum }_{j = 1}^{n} φ ( {d}_{k , j} , {θ}_{k , j} ) = [ {w}_{k , 1} , {w}_{k , 2} , … , {w}_{k , m} ] ,$$
wherein d_{k,j} and θ_{k,j} are the gradient magnitude d and the gradient angle θ of a j^{th} pixel in a k^{th} region, φ is a gradient histogram statistical function, k is greater than or equal to 1 and less than or equal to m, and n is a quantity of pixels in the k^{th} region.

15. The authentication method using the user feature template established by the method according to claim 8, wherein extracting the palm vein feature data from the picked palm images comprises:
obtaining a key feature point of the picked palm image, wherein the key feature point does not change with a palm size, rotation and deflection of the palm, and palm image brightness, that is, calculating and searching response maps of the picked palm image in different Gaussian scale spaces by using a designed fuzzy kernel function, performing subtraction to obtain a Gaussian difference image, and then positioning a stable extreme point in a position space and a scale space; and
establishing a descriptor for the key feature point, wherein the key feature point is a stable feature point, and the descriptor is stable feature data, that is, in a Gaussian scale space in which a pole point is located, taking the extreme point as an origin, counting gradients and directions of pixels in an adjacent region by using a histogram, to form the descriptor.

16. The authentication method using the user feature template established by the method according to claim 8, wherein in a case that the first feature template is formed, the method comprises: performing three-dimensional matching on the stable feature point to obtain a successfully matched key point, wherein the three-dimensional matching comprises: matching the descriptor of the stable feature point of an image to be matched, performing perspective transformation on a successfully matched stable feature point to switch the successfully matched stable feature point to a same coordinate system, performing matching on the stable feature point in the coordinate system, and removing an unstable feature point while ensuring overall consistency of the matching; and fusing successfully matched key points to form an optimal fusion feature point, wherein the optimal fusion feature point forms the first feature template, and comparison performed by using the optimal fusion feature point is not influenced by a size, a position, an angle, an inclination, and a shape of the palm.

17. The electronic device, comprising:
a memory, wherein the memory stores execution instructions; and
a processor, wherein the processor executes the execution instructions stored by the memory, to enable the processor to perform the method according to claim 10, wherein further comprising: obtaining optimal vector data of the picked palm image of each position, that is, obtaining an optimal picked palm image from the picked palm image of each position, and obtaining the optimal vector data of each position based on the optimal picked palm image; or obtaining optimal palm vein feature data from the palm vein feature data of the picked palm image of each position, and obtaining the optimal vector data of each position based on the optimal palm vein feature data; and
forming the user feature template based on the one first feature template, that is, fusing the one first feature template with the optimal vector data of each position to form the user feature template.

18. The electronic device, comprising:
a memory, wherein the memory stores execution instructions; and
a processor, wherein the processor executes the execution instructions stored by the memory, to enable the processor to perform the method according to claim 10, wherein picking out the picked palm image satisfying the preset condition comprises:
extracting regions of interest of the shot palm images;
obtaining image vector data of the regions of interest; and
comparing the image vector data of the palm images, to pick out the picked palm image satisfying the preset condition.

19. The electronic device, comprising:
a memory, wherein the memory stores execution instructions; and
a processor, wherein the processor executes the execution instructions stored by the memory, to enable the processor to perform the method according to claim 10, wherein in a process of comparing the image vector data of the shot palm images, the palm images are compared pairwise to pick out palm images with a high similarity of the different positions, wherein if a comparison threshold of two palm images is greater than a preset threshold, a similarity of the two palm images is considered to be high.

20. The electronic device, comprising:
a memory, wherein the memory stores execution instructions; and
a processor, wherein the processor executes the execution instructions stored by the memory, to enable the processor to perform the method according to claim 10, wherein extracting the palm vein feature data from the picked palm images comprises:
obtaining a key feature point of the picked palm image, wherein the key feature point does not change with a palm size, rotation and deflection of the palm, and palm image brightness, that is, calculating and searching response maps of the picked palm image in different Gaussian scale spaces by using a designed fuzzy kernel function, performing subtraction to obtain a Gaussian difference image, and then positioning a stable extreme point in a position space and a scale space; and
establishing a descriptor for the key feature point, wherein the key feature point is a stable feature point, and the descriptor is stable feature data, that is, in a Gaussian scale space in which a pole point is located, taking the extreme point as an origin, counting gradients and directions of pixels in an adjacent region by using a histogram, to form the descriptor.
